(19) United States
(12) Patent Application Publication
(10) Pub. No.: US 2022/0173525 A1
(43) Pub. Date: Jun. 2, 2022

(54) ANTENNA MODULE AND ELECTRONIC DEVICE

(71) Applicant: GUANGDONG OPPO MOBILE TELECOMMUNICATIONS CORP., LTD., Dongguan (CN)

(72) Inventor: Yuhu JIA, Dongguan (CN)

(21) Appl. No.: 17/676,385

(22) Filed: Feb. 21, 2022

Related U.S. Application Data
(63) Continuation of application No. PCT/CN2020/118791, filed on Sep. 29, 2020.

(30) Foreign Application Priority Data
Oct. 31, 2019 (CN) 201911053818.9

(51) Int. Cl. H01Q 21/00; H01Q 21/30; H01Q 21/06

(52) U.S. Cl. CPC H01Q 21/0025; H01Q 21/065; H01Q 21/30

(57) ABSTRACT

An antenna module and an electronic device are provided. The antenna module includes a dielectric substrate, a patch array, a feed ground layer, a feed ground portion, and a feeding portion. The patch array is carried on the dielectric substrate and includes at least two patch units, and each of the at least two patch units defines at least one through hole. The feed ground layer carries the dielectric substrate and is spaced apart from the patch array. The feed ground portion is electrically connected between the patch array and the feed ground layer. The feeding portion is configured to feed a current signal, where the current signal is coupled to the patch array to excite the patch array to resonate in a first frequency band, and the current signal is coupled to the feed ground portion to excite the feed ground portion to resonate in a second frequency band.

### CROSS-REFERENCE TO RELATED APPLICATIONS

This application is a continuation of International Application No. PCT/CN2020/118791, filed on Sep. 29, 2020, which claims priority to Chinese Patent Application No. 201911053818.9, filed on Oct. 31, 2019, the entire disclosures of which are incorporated herein by reference.

### TECHNICAL FIELD

This disclosure relates to the technical field of electronics, and in particular to an antenna module and an electronic device.

### BACKGROUND

Millimeter wave (mmWave) has characteristics of high carrier frequency and large bandwidth, and is a main means to realize ultra-high data transmission rate of the fifth generation (5G) mobile communication technology. Due to intense space losses of electromagnetic waves in a mmWave frequency band, a wireless communication system using the mmWave frequency band needs a framework using a phased array. A phase of each array element is distributed according to a certain rule through a phase shifter, so as to form a beam with a high gain, and the beam is scanned within a certain spatial range by changing phase shift. In order to achieve usage of an antenna module in an electronic device, a structural dimension of the antenna module is challenged.

### SUMMARY

An antenna module is provided in the implementations of the present disclosure. The antenna module includes a dielectric substrate, a patch array, a feed ground layer, a feed ground portion, a feeding portion. The patch array is carried on the dielectric substrate and includes at least two patch units. Each of the at least two patch units defines at least one through hole. The feed ground layer carries the dielectric substrate and is spaced apart from the patch layer. The feed ground portion is electrically connected between the patch array and the feed ground layer. The feeding portion is configured to feed a current signal, where the current signal is coupled to the patch array to excite the patch array to resonate in a first frequency band, and the current signal is coupled to the feed ground portion to excite the feed ground portion to resonate in a second frequency band.

An electronic device is further provided in the present disclosure. The electronic device includes a main board and the antenna module which is provided in any of the above implementations. The antenna module is electrically connected with the main board, and the antenna module is configured to receive and emit a radio frequency (RF) signal of the first frequency band and the second frequency band under control of the main board.

### BRIEF DESCRIPTION OF THE DRAWINGS

In order to describe technical solutions of implementations of the present disclosure more clearly, the following will give a brief introduction to the accompanying drawings used for describing the implementations. Apparently, the accompanying drawings hereinafter described are some implementations of the present disclosure. Based on these drawings, those of ordinary skill in the art can also obtain other drawings without creative effort.

FIG. 1 is a schematic structural view illustrating an antenna module provided in implementations of the present disclosure.

FIG. 2 is a schematic structural view illustrating the antenna module provided in FIG. 1, which takes only one module as an example.

FIG. 3 is a schematic structural view illustrating the antenna module provided in FIG. 2 from one perspective.

FIG. 4 is a schematic structural view illustrating the antenna module provided in FIG. 2 from another perspective.

FIG. 5 is a schematic structural view illustrating disposing of a feed ground point on a patch unit of an antenna module provided in implementations of the present disclosure.

FIG. 6 is a schematic structural view illustrating the antenna module provided in FIG. 5 taken on XZ-plane.

FIG. 7 is a schematic structural view illustrating an antenna module taken on XY-plane provided in implementations of the present disclosure.

FIG. 8 is a schematic structural view illustrating an antenna module taken on XY-plane provided in other implementations of the present disclosure.

FIG. 9 is a schematic structural view illustrating an antenna module taken on XY-plane provided in other implementations of the present disclosure.

FIG. 10 is a schematic structural view illustrating a feed ground portion in an antenna module provided in implementations of the present disclosure.

FIG. 11 is a schematic structural view illustrating a feed ground portion in an antenna module provided in other implementations of the present disclosure.

FIG. 12 is a schematic structural view illustrating a feed ground portion in an antenna module provided in other implementations of the present disclosure.

FIG. 13 is a schematic structural view illustrating a feed ground portion in an antenna module provided in other implementations of the present disclosure.

FIG. 14 is a schematic structural view illustrating an antenna module taken on YZ-plane provided in implementations of the present disclosure.

FIG. 15 is a schematic structural view illustrating a feeding portion in the antenna module provided in FIG. 14.

FIG. 16 is another schematic structural view illustrating a feeding portion in the antenna module provided in FIG. 14.

FIG. 17 is a schematic structural view of a cross-sectional view illustrating an electronic device provided in implementations of the present disclosure.

FIG. 18 is a schematic structural view of a cross-sectional view illustrating an electronic device provided in other implementations of the present disclosure.

FIG. 19 is a schematic structural view of a cross-sectional view illustrating an electronic device provided in other implementations of the present disclosure.

FIG. 20 is a schematic structural view of a cross-sectional view illustrating an electronic device provided in other implementations of the present disclosure.

FIG. 21 is a schematic structural view of a cross-sectional view illustrating an electronic device provided in other implementations of the present disclosure.

FIG. 22 is a schematic view illustrating a return loss curve of each port of a 1×4 antenna array.

FIG. 23 is a schematic view illustrating isolation curves between patch-unit ports of a 1×4 antenna array.

FIG. 24 is a radiation gain pattern illustrating an antenna module in a frequency band of 24.25 Gigahertz (GHz) in a main direction.

FIG. 25 is a radiation gain pattern illustrating an antenna module in a frequency band of 24.25 GHz in a 45-degree direction.

FIG. 26 is a radiation gain pattern illustrating an antenna module in a frequency band of 28 GHz.

FIG. 27 is a radiation gain pattern illustrating an antenna module in a frequency band of 28 GHz in a 45-degree direction.

FIG. 28 is a radiation gain pattern illustrating an antenna module in a frequency band of 39 GHz.

FIG. 29 is a radiation gain pattern illustrating an antenna module in a frequency band of 39 GHz in a 30-degree direction.

FIG. 30 is a schematic view illustrating a variation curve of a peak gain of an antenna module with a frequency.

### DETAILED DESCRIPTION

Technical solutions of implementations of the present disclosure will be described clearly and completely with reference to accompanying drawings in the implementations of the present disclosure. Apparently, the implementations described herein are merely some implementations, rather than all implementations, of the present disclosure. Based on the implementations of the present disclosure, all other implementations obtained by those of ordinary skill in the art without creative effort shall fall within the protection scope of the disclosure. It should be noted that words “first”, “second”, and other words appearing in the present disclosure are only used to distinguish names of components, and do not represent the number or order of occurrence.

An antenna module is provided in implementations of the present disclosure. The antenna module includes a dielectric substrate, a patch array, a feed ground layer, a feed ground portion, and a feeding portion. The patch array is carried on the dielectric substrate and includes at least two patch units. Each of the at least two patch units defines at least one through hole. The feed ground layer carries the dielectric substrate and is spaced apart from the patch layer. The feed ground portion is electrically connected between the patch array and the feed ground layer. The feeding portion is configured to feed a current signal, where the current signal is coupled to the patch array to excite the patch array to resonate in a first frequency band, and the current signal is coupled to the feed ground portion to excite the feed ground portion to resonate in a second frequency band.

In an implementation, the patch array includes a first patch and a second patch spaced apart from the first patch. The first patch defines a first through hole, and the second patch defines a second through hole. The first patch and the second patch are in mirror symmetry.

In an implementation, the first patch includes a first feed ground point, and the second patch includes a second feed ground point. The feed ground portion includes a first feed ground member and a second feed ground member spaced apart from the first feed ground member. A length of at least one of the first feed ground member and the second feed ground member is greater than a distance between a surface of the patch array facing the feed ground layer and a surface of the feed ground layer facing the patch array. The first feed ground member is electrically connected between the first feed ground point and the feed ground layer, and the second feed ground member is electrically connected between the second feed ground point and the feed ground layer.

In an implementation, the at least one through hole is implemented as multiple through holes, and the multiple through holes are arranged in an array on each of the at least two patch units.

In an implementation, each of the at least one through hole penetrates through a middle part of each of the at least two patch units; or each of the at least one through hole penetrates through an edge part of each of the at least two patch units.

In an implementation, each of the at least one through hole is in any one or any combination of: a rectangle, a circle, an ellipse, a triangle, a pentagon, a hexagon, a cross, a quincunx, a C-shape, a U-shape, a S-shape, and a Jerusalem cross.

In an implementation, the first patch defines a first accommodating hole at an edge part of the first patch away from the feeding portion, the second patch defines a second accommodating hole at an edge part of the second patch away from the feeding portion, each of the first accommodating hole and the second accommodating hole is a through hole, and an opening direction of the first accommodating hole is opposite to an opening direction of the second accommodating hole.

In an implementation, the first patch defines a first curved gap at a middle part of the first patch away from the feeding portion, the second patch defines a second curved gap at a middle part of the second patch away from the feeding portion, each of the first curved gap and the second curved gap is a through hole, and an opening direction of the first curved gap is opposite to an opening direction of the second curved gap.

In an implementation, the first patch defines multiple first metallization via holes arranged in an array at an edge part of the first patch close to the feeding portion, and the second patch defines multiple second metallization via holes arranged in an array at an edge part of the second patch close to the feeding portion.

In an implementation, the feed ground portion includes multiple feed ground members, the multiple feed ground members are in one-to-one correspondence with the multiple first metallization via holes and the multiple second metallization via holes, the multiple feed ground members are electrically connected with the multiple first metallization via holes to electrically connect the first patch and the feed ground layer, and the multiple feed ground members are electrically connected with the multiple second metallization via holes to electrically connect the second patch and the feed ground layer.

In an implementation, a length of the feed ground portion is greater than the distance between the surface of the patch array facing the feed ground layer and the surface of the feed ground layer facing the patch array.

In an implementation, the feed ground portion includes a first part, a second part, and a third part which are bendably connected, the second part is connected between the first part and the third part, the first part is electrically connected with the patch array, and the third part is electrically connected with the feed ground layer.

In an implementation, the first part is perpendicular to a plane on which the patch array is located, the third part is perpendicular to a plane on which the feed ground layer is located, a first preset included angle is defined between the first part and the second part, a second preset included angle is defined between the second part and the third part, the first preset included angle ranges from 80°˜100°, and the second preset included angle ranges from 80°˜100°.

In an implementation, the second part is a long-strip patch, a square patch, or a circular patch, the second part has a first end and a second end opposite to the first end, the first end has a first electrical connection end, the second end has a second electrical connection end, the first part is electrically connected with the first electrical connection end, and the third part is electrically connected with the second electrical connection end.

In an implementation, the second part defines an escape hole, the escape hole avoids the first electrical connection end and the second electrical connection end, and the escape hole and the at least one through hole are arranged in a staggered manner.

In an implementation, the patch array constitutes an electric dipole antenna, the feed ground portion constitutes a magnetic dipole antenna, and a radiation direction of the patch array keeps orthogonal to a radiation direction of the feed ground portion.

In an implementation, a projection of the patch array on the dielectric substrate is located within a range of a projection of the feed ground layer on the dielectric substrate.

In an implementation, the first frequency band is different from the second frequency band, a minimum value of the first frequency band is greater than a maximum value of the second frequency band, the first frequency band and the second frequency band together constitute a preset frequency band, and the preset frequency band at least includes a full frequency band of 3rd generation partnership project (3 GPP) millimeter wave (mmWave).

In an implementation, a size of the feed ground layer is λ×λ, and a distance between the patch array and the feed ground layer is λ/4, λ being a wavelength corresponding to an intermediate value of a center frequency of the first frequency band and a center frequency of the second frequency band.

In an implementation, the antenna module includes a feeding port. The feeding portion has a first section and a second section bendably connected with the first section, the first section is electrically connected with the feeding port, the first section is disposed close to the feed ground portion, the second section is disposed close to the patch array, and the second section is located between two adjacent patch units.

In an implementation, the second section and the patch array are disposed side by side, and the second section and the patch array keep flush with each other.

In an implementation, the first section keeps perpendicular to the second section.

In an implementation, the antenna module includes a feeding port, wherein the feeding portion has a first section, a second section, and a third section which are bendably connected, the second section is connected between the first section and the third section, the first section is electrically connected with the feeding port, the first section is disposed closed to the feed ground portion, the second section is disposed closed to the patch array, an extension direction of the third section keeps consistent with an extension direction of the first section, and the third section is configured to perform spatial impedance matching on a radio frequency (RF) signal of the first frequency band and the second frequency band received and emitted by the patch array.

In an implementation, a distance between the third section and the feed ground layer ranges from λ/8˜λ/4, λ being a wavelength corresponding to an intermediate value of a center frequency of the first frequency band and a center frequency of the second frequency band.

An electronic device is also provided in implementations of the present disclosure. The electronic device includes a main and the antenna module which is illustrated in any of above implementations. The antenna module is electrically connected with the main board, and the antenna module is configured to receive and emit RF signal of the first frequency band and the second frequency band under control of the main board.

In an implementation, the electronic device further includes a battery cover. The battery cover is spaced apart from the antenna module, the battery cover is at least partially located within a radiation direction range of receiving and emitting a RF signal by the antenna module. The antenna module is configured to receive and emit the RF signal of the first frequency band and the second frequency band through the battery cover under control of the main board. The battery cover is made of any one or more of: plastic, glass, sapphire, and ceramic.

In an implementation, the main board is located at a side of the antenna module away from the battery cover, and the main board is configured to reflect the RF signal of the first frequency band and the second frequency band emitted by the antenna module toward a side where the battery cover is located.

In an implementation, the battery cover includes a back plate and a side plate surrounding the back plate, and the side plate is located within the radiation direction range of receiving and emitting the RF signal of the first frequency band and the second frequency band by the antenna module.

In an implementation, the battery cover includes a back plate and a side plate surrounding the back plate, and the back plate is located within the radiation direction range of receiving and emitting the RF signal of the first frequency band and the second frequency band by the antenna module.

In an implementation, the battery cover includes a back plate and a side plate surrounding the back plate. The antenna module includes a first module and a second module, the first module has a radiation surface facing the back plate, and the second module has a radiation surface facing the side plate.

In an implementation, the electronic device further includes a screen. The screen is spaced apart from the antenna module, and the screen is at least partially located within the radiation direction range of receiving and emitting the RF signal of the first frequency band and the second frequency band by the antenna module.

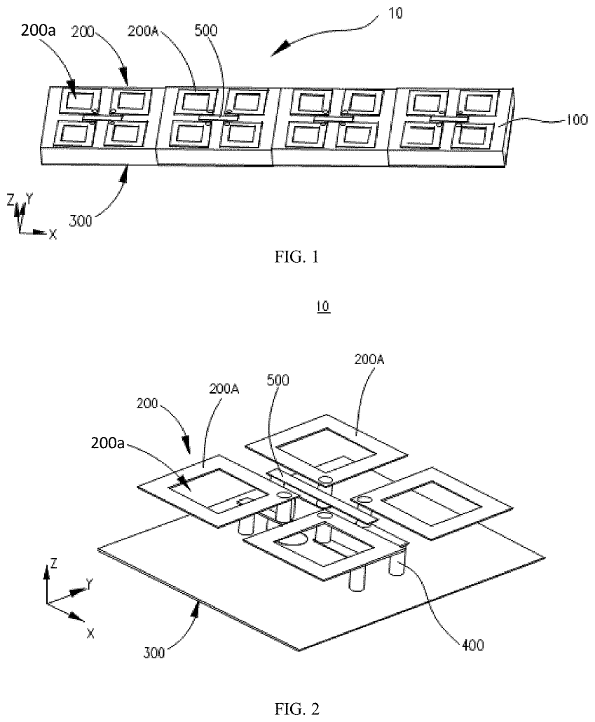

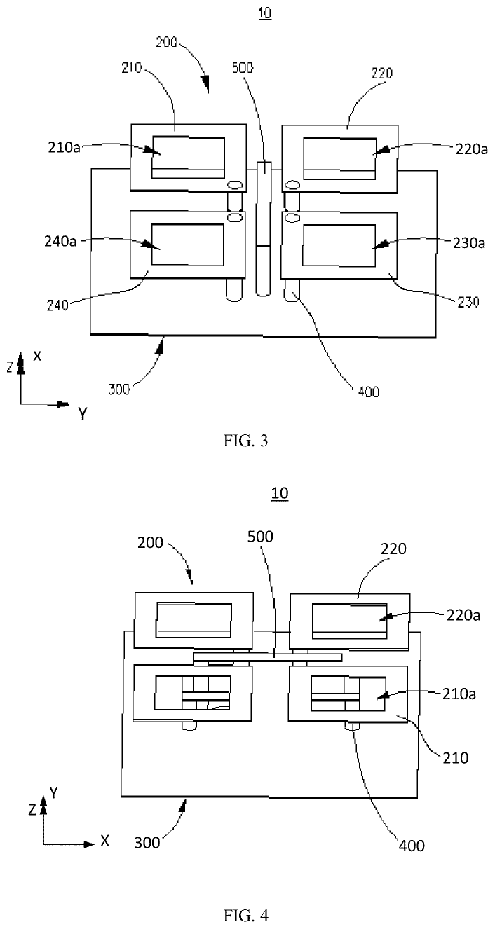

Reference can be made to FIG. 1, FIG. 2, FIG. 3, and FIG. 4, in order to observe an inner structure of an antenna module clearly, an example of only one antenna module is taken for illustration in FIG. 2, FIG. 3, and FIG. 4, and a dielectric substrate 100 is omitted. An antenna module 10 provided in implementations of the present disclosure includes a dielectric substrate 100, a patch array 200, a feed ground layer 300, a feed ground portion 400, and a feeding portion 500. The patch array 200 is carried on the dielectric substrate 100 and includes at least two patch units 200A, each of the at least two patch units 200A defines at least one through hole 200a. The feed ground layer 300 carries the dielectric substrate 100 and is spaced apart from the patch array 200. The feed ground portion 400 is electrically connected between the patch array 200 and the feed ground layer 300. The feeding portion 500 is configured to feed a current signal. The current signal is coupled to the patch array 200 to excite the patch array 200 to resonate in a first frequency band, and the current signal is coupled to the feed ground portion 400 to excite the feed ground portion 400 to resonate in a second frequency band.

In an implementation, the first frequency band may be different from the second frequency band, so as to realize receiving and emitting of a signal of a dual frequency band, which can make the antenna module 10 applicable to different situations. In another implementation, the first frequency band may also be the same as the second frequency band, in this case, receiving and emitting of a signal of a single frequency band can be realized, which helps to enhance strength of the RF signal received and emitted by the antenna module 10.

The antenna module 10 may be a mmWave module. The antenna module 10 is configured to receive and emit a mmWave RF signal of a preset frequency band. The antenna module 10 may be formed by a high density interconnector (HDI) process or an integrated circuit (IC) substrate process. The dielectric substrate 100 is formed by pressing multiple layers of dielectric plates. The patch array 200, the feed ground layer 300, the feed ground portion 400, and the feeding portion 500 are all carried on the dielectric substrate 100. The feed ground layer 300 is spaced apart from the patch array 200. The feed ground portion 400 is connected between the feed ground layer 300 and the patch array 200. The feed ground portion 400 has a bendable structure. A length of the feed ground portion 400 is greater than a distance between a surface of the patch array 200 facing the feed ground layer 300 and a surface of the feed ground layer 300 facing the patch array 200, thus a transmission path of a current can be extended, which in turn improves a bandwidth of the RF signal. Meanwhile, a thickness of the antenna module 10 can be reduced.

When the current signal is fed into the feeding portion 500, the current signal is coupled to the patch array 200, which can make the patch array 200 resonate in the first frequency band, that is, the patch array 200 is caused to generate a RF signal of the first frequency band. The current signal is coupled to the feed ground portion 400, which can make the feed ground portion 400 resonate in the second frequency band, that is, the feed ground portion 400 is caused to generate a RF signal of the second frequency band. When the first frequency band is different from the second frequency band, the RF signal of the first frequency band may be a high-frequency signal, and the RF signal of the second frequency band may be a low-frequency signal. Furthermore, a minimum value of the first frequency band is greater than a maximum value of the second frequency band, the first frequency band and the second frequency band together constitute a preset frequency band, and the preset frequency band at least includes the full frequency band of the 3GPP mmWave.

According to the protocol of the 3GPP technical specification (TS) 38.101, two frequency bands are mainly used in the 5th generation (5G) mobile communication technology: a frequency range 1 (FR1) band and a frequency range 2 (FR2) band. The FR1 band has a frequency range of 450 megahertz (MHz)˜6 gigahertz (GHz), and is also known as the sub-6 GHz frequency band. The FR2 band has a frequency range of 24.25 Ghz˜52.6 Ghz, and is generally known as the mmWave frequency band. The 3GPP Release 15 specifies that present 5G mmWave frequency bands include: n257 (26.5˜29.5 Ghz), n258 (24.25˜27.5 Ghz), n261 (27.5˜28.35 Ghz), and n260 (37˜40 GHz). When the first frequency band is different from the second frequency band, the first frequency band may be the mmWave frequency band, in this case, the second frequency band may be the sub-6 GHz frequency band. Each of the first frequency band and the second frequency band may also be the mmWave frequency band, where the first frequency band is a high-frequency mmWave frequency band, and the second frequency band is a low-frequency mmWave frequency band.

In an implementation, the patch array 200 constitutes an electric dipole antenna, and the feed ground portion 400 constitutes a magnetic dipole antenna. Since a current direction on the patch array 200 is on a horizontal plane and a current direction on the feed ground portion 400 is in a vertical direction, therefore, orthogonality is kept, and a radiation direction of the patch array 200 keeps orthogonal to a radiation direction of the feed ground portion 400.

The patch array 200 includes multiple patch units 200A, each of the multiple patch units 200A constitutes an antenna radiator. The feeding portion 500 extends to a position close to the patch array 200, and the feeding portion 500 extends to a position close to the feed ground portion 400, which facilitates the current signal on the feeding portion 500 being coupled to the patch array 200 and the feed ground portion 400. Specifically, when the current signal on the feeding portion 500 is coupled to the patch array 200 and the feed ground portion 400 respectively, since a transmission direction of a coupled current signal on the patch array 200 keeps orthogonal to a transmission direction of a coupled current signal on the feed ground portion 400, a direction of a RF signal radiated by the patch array 200 keeps orthogonal to a direction of a RF signal radiated by the feed ground portion 400. The patch array 200 may constitute a 2×2 antenna array, a 2×4 antenna array, or a 4×4 antenna array. When multiple antenna radiators constitute an antenna array, the multiple antenna radiators may operate in the same frequency band. The multiple antenna radiators may also operate in different frequency bands, which helps to broaden a frequency band range of the antenna module 10. Furthermore, each of the multiple patch units 200A defines at least one through hole 200a. When a current on the feeding portion 500 is coupled to each of the multiple patch units 200A, due to existence of the at least one through hole 200a on each of the multiple patch units 200A, a coupled current can be transmitted in a ring shape and a transmission path of the coupled current on each of the multiple patch units 200A can be extended, such that a bandwidth of the antenna module 10 can be improved on condition that an occupied volume of the antenna module 10 is reduced. Each of the at least one through hole 200a may be in any one or any combination of: a rectangle, a circle, an ellipse, a triangle, a pentagon, a hexagon, a cross, a quincunx, a C-shape, a U-shape, a S-shape, and a Jerusalem cross.

In an implementation, the patch array 200 includes a first patch 210 and a second patch 220 spaced apart from the first patch 210. The first patch 210 defines a first through hole 210a, the second patch 220 defines a second through hole 220a, and the first patch 210 and the second patch 220 are disposed in mirror symmetry.

The first patch 210 constitutes a first radiator, and the second patch 220 constitutes a second radiator. Each of the first patch 210 and the second patch 220 is a metal patch. A size of the first through hole 210a keeps consistent with a size of the second through hole 220a. The first patch 210 and the second patch 220 are disposed in mirror symmetry. In this case, when the current signal on the feeding portion 500 is coupled to the first patch 210 and the second patch 220, flow directions of the current on the first patch 210 and the second patch 220 can be relatively uniform, and radiation performance of the antenna module 10 can be relatively stable. Each of the first patch 210 and the second patch 220 may be in a rectangle, a circle, a triangle, a pentagon, a hexagon, etc. Each of the first through hole 210a and the second through hole 220a may be in any one or any combination of: a rectangle, a circle, an ellipse, a triangle, a pentagon, a hexagon, a cross, a quincunx, a C-shape, a U-shape, a S-shape, and a Jerusalem cross.

In other implementations, the first through hole 210a is implemented as multiple first through holes 210a, and the second through hole 220a is implemented as multiple second through holes 220a. The multiple first through holes 210a and the multiple second through holes 220a are arranged in an array on the multiple patch units 200A. Since the multiple first through holes 210a and the multiple second through holes 220a are arranged in an array on the multiple patch units 200A, there are multiple transmission paths of the coupled current on the multiple patch units 200A after the current on the feeding portion 500 is coupled to the multiple patch units 200A, which helps to extend the transmission path of the coupled current, thereby improving the bandwidth of the antenna module 10 on condition that the occupied volume of the antenna module 10 is reduced.

In an implementation, the first through hole 210a and the second through hole 220a penetrate through a middle part of the multiple patch units 200A. Due to existence of the first through hole 210a and the second through hole 220a, when the current on the feeding portion 500 is coupled to the multiple patch units 200A, the coupled current is transmitted along a ring path on each of the multiple patch units 200A, which is equivalent to extending the transmission path of the coupled current, thereby improving the bandwidth of the antenna module 10 on condition that the occupied volume of the antenna module 10 is reduced.

In another implementation, the first through hole 210a and the second through hole 220a penetrate through an edge part of the multiple patch units 200A. Due to the existence of the first through hole 210a and the second through hole 220a, an area of the multiple patch units 200A can be reduced, such that a stronger coupled current is generated on each of the multiple patch units 200A per unit area, thereby enhancing a radiation intensity of the antenna module 10 on condition that the occupied volume of the antenna module 10 is reduced.

In an implementation, a projection of the patch array 200 on the dielectric substrate 100 is located within a range of a projection of the feed ground layer 300 on the dielectric substrate 100. A size of the feed ground layer 300 is λ×λ, and a distance between the patch array 200 and the feed ground layer 300 is λ/4, λ being a wavelength corresponding to an intermediate value of a center frequency of the first frequency band and a center frequency of the second frequency band.

Specifically, λ is a wavelength corresponding to a fixed frequency, and the fixed frequency is the intermediate value of the center frequency of the first frequency band and the center frequency of the second frequency band. When the size of the feed ground layer 300 satisfies λ×λ and the distance between the patch array 200 and the feed ground layer 300 satisfies λ/4, the antenna module 10 can reach a relatively high radiation performance. In other words, an operating frequency of the antenna module 10 is closely related to a structural dimension of the antenna module 10, different structural dimensions of the antenna module 10 can affect the operating frequency of the antenna module 10 and the radiation performance of the antenna module 10.

In addition to the first patch 210 and the second patch 220, the patch array 200 further includes a third patch 230 and a fourth patch 240 spaced apart from the third patch 230. The third patch 230 defines a third through hole 230a, the fourth patch 240 defines a fourth through hole 240a, and the third patch 230 and the fourth patch 240 are disposed in mirror symmetry.

The third patch 230 constitutes a third radiator, and the fourth patch 240 constitutes a fourth radiator. Each of the first patch 210 and the second patch 220 is a metal patch. A size of the third through hole 230a keeps consistent with a size of the fourth through hole 240a. The third patch 230 and the fourth patch 240 are disposed in mirror symmetry. In this case, when the current signal on the feeding portion 500 is coupled to the third patch 230 and the fourth patch 240, flow directions of the current on the third patch 230 and the fourth patch 240 can be relatively uniform, and the radiation performance of the antenna module 10 can be relatively stable. Each of the third patch 230 and the fourth patch 240 may be in a rectangle, a circle, a triangle, a pentagon, a hexagon, etc. Each of the third through hole 230a and the fourth through hole 240a may be in any one or any combination of: a rectangle, a circle, an ellipse, a triangle, a pentagon, a hexagon, a cross, a quincunx, a C-shape, a U-shape, a S-shape, and a Jerusalem cross.

In other implementations, the third through hole 230a is implemented as multiple third through holes 230a, and the fourth through hole 240a is implemented as multiple fourth through holes 240a. The multiple third through holes 230a and the multiple fourth through holes 240a are arranged in an array on the multiple patch units 200A. Since the multiple third through holes 230a and the multiple fourth through holes 240a are arranged in an array on the multiple patch units 200A, there are multiple transmission paths of the coupled current on the multiple patch units 200A after the current on the feeding portion 500 is coupled to the multiple patch units 200A, which helps to extend the transmission path of the coupled current, thereby improving the bandwidth of the antenna module 10 on condition that the occupied volume of the antenna module 10 is reduced.

In the antenna module 10 provided in implementations of the present disclosure, each of the multiple patch units 200A defines at least one through hole 200a, which can extend the transmission path of the current, broaden an operating frequency band of the antenna module 10, and reduce the volume of the antenna module 10 to make the antenna module 10 miniaturized. In addition, the feeding portion 500 performs coupling feed on the antenna array and the feed ground portion 400, which can make the antenna module 10 operate in the same frequency band or different frequency bands, thereby helping to realize receiving and emitting of the RF signal of the single frequency band or the dual frequency band.

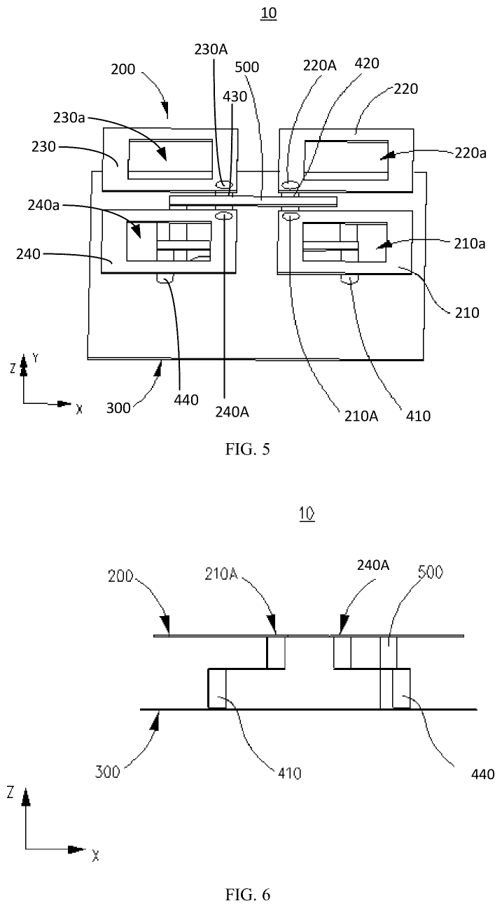

Reference can continue to be made to FIG. 5 and FIG. 6, the first patch 210 includes a first feed ground point 210A, and the second patch 220 includes a second feed ground point 220A. The feed ground portion 400 includes a first feed ground member 410 and a second feed ground member 420 spaced apart from the first feed ground member 410. A length of at least one of the first feed ground member 410 and the second feed ground member 420 is greater than a distance between a surface of the patch array 200 facing the feed ground layer 300 and a surface of the feed ground layer 300 facing the patch array 200. The first feed ground member 410 is electrically connected between the first feed ground point 210A and the feed ground layer 300, and the second feed ground member 420 is electrically connected between the second feed ground point 220A and the feed ground layer 300. The first feed ground member 410 is bent toward a side of the first patch 210 away from the feeding portion 500, and the second feed ground member 420 is bent toward a side of the second patch 220 away from the feeding portion 500. The first feed ground member 410 and the second feed ground member 420 can extend the transmission path of the coupled current, and reduce the thickness of the antenna module 10 while increasing the bandwidth of the RF signal received and emitted by the antenna module 10.

Reference can continue to be made to FIG. 5 and FIG. 6, the third patch 230 includes a third feed ground point 230A, and the fourth patch 240 includes a fourth feed ground point 240A. The feed ground portion 400 may further include a third feed ground member 430 and a fourth feed ground member 440 spaced apart from the third feed ground member 430. A length of at least one of the third feed ground point 230A and the fourth feed ground member 440 is greater than a distance between a surface of the patch array 200 facing the feed ground layer 300 and a surface of the feed ground layer 300 facing the patch array 200. The third feed ground member 430 is electrically connected between the third feed ground point 230A and the feed ground layer 300, and the fourth feed ground member 440 is electrically connected between the second feed ground point 220A and the feed ground layer 300. The third feed ground member 430 is bent toward a side of the third patch 230 close to the feeding portion 500, and the fourth feed ground member 440 is bent toward a side of the fourth patch 240 close to the feeding portion 500. The third feed ground member 430 and the fourth feed ground member 440 can extend the transmission path of the coupled current, and reduce the thickness of the antenna module 10 while increasing the bandwidth of the RF signal received and emitted by the antenna module 10.

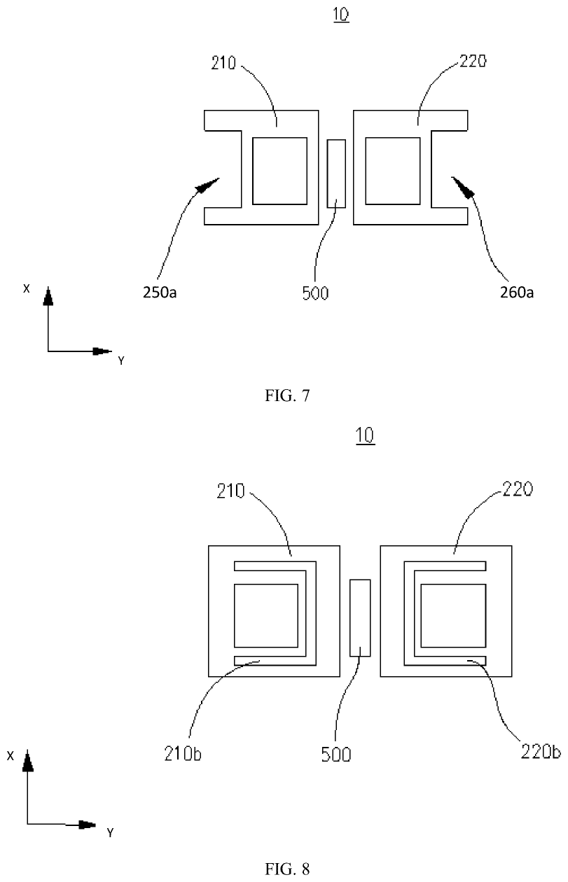

Reference can continue to be made to FIG. 7, the first patch 210 defines a first accommodating hole 250a at an edge part of the first patch 210 away from the feeding portion 500, and the second patch 220 defines a second accommodating hole 260a at an edge part of the second patch 220 away from the feeding portion 500. Each of the first accommodating hole 250a and the second accommodating hole 260a is a through hole, and an opening direction of the first accommodating hole 250a is opposite to an opening direction of the second accommodating hole 260a.

The first accommodating hole 250a may be a rectangular hole or a curved hole. The second accommodating hole 260a may be a rectangular hole or a curved hole. A size of the first accommodating hole 250a keeps consistent with a size of the second accommodating hole 260a, such that when the current signal on the feeding portion 500 is coupled to the first patch 210 and the second patch 220, distribution of the coupled current signal on the first patch 210 and the second patch 220 can be relatively uniform, which helps to improve the radiation performance of the antenna module 10.

Reference can continue to be made to FIG. 8, the first patch 210 defines a first curved gap 210b at a middle part of the first patch 210 away from the feeding portion 500, the second patch 220 defines a second curved gap 220b at a middle part of the second patch 220 away from the feeding portion 500, each of the first curved gap 210b and the second curved gap 220b is a through hole, and an opening direction of the first curved gap 210b is opposite to an opening direction of the second curved gap 220b.

A curved gap may be a C-shaped groove, a U-shaped groove, a broken-line shaped groove, etc. Since the first curved gap 210b is located in the middle of the first patch 210 and the second curved gap 220b is located in the middle of the second patch 220, the current signal coupled to the first patch 210 and the second patch 220 by the feeding portion 500 is transmitted in a ring shape, which helps to extend the transmission path of the current, thereby broadening the bandwidth of the RF signal received and emitted by the antenna module 10. The first patch 210 and the second patch 220 are disposed in mirror symmetry, which can ensure that performance of the first patch 210 keeps consistent with performance of the second patch 220, so as to make the radiation performance of the antenna module 10 relatively stable. In addition, each of the multiple patch units 200A defines the curved gap, which can reduce the volume occupied by the antenna module 10 and realize the miniaturization of the antenna module 10.

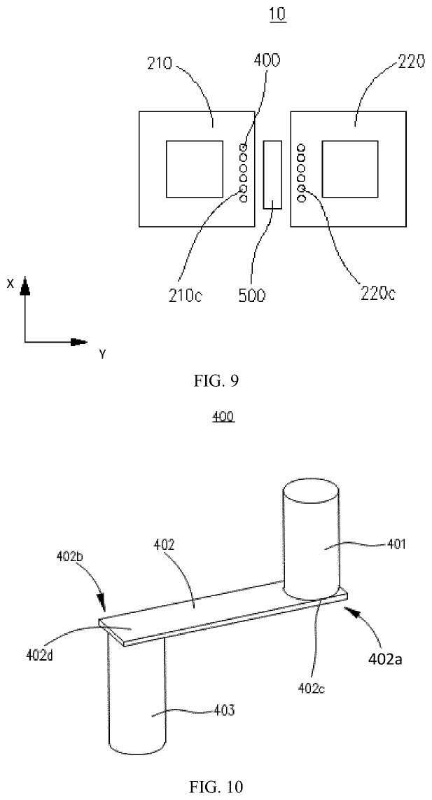

Reference can continue to be made to FIG. 9, the first patch 210 defines multiple first metallization via holes 210c arranged in an array at an edge part of the first patch 210 close to the feeding portion 500, and the second patch 220 defines multiple second metallization via holes 220c arranged in an array at an edge part of the second patch 220 close to the feeding portion 500.

Distances between any two adjacent first metallization via holes 210c keep consistent, and distances between any two adjacent second metallization via holes 220c keep consistent. The multiple first metallization via holes 210c and the multiple second metallization via holes 220c are used to isolate the first patch 210 and the second patch 220, so as to prevent mutual interference between the first patch 210 and the second patch 220.

Furthermore, the feed ground portion 400 includes multiple feed ground members, and the multiple feed ground members are in one-to-one correspondence with the multiple first metallization via holes 210c and the multiple second metallization via holes 220c, the multiple feed ground members are electrically connected with the multiple first metallization via holes 210c to electrically connect the first patch 210 and the feed ground layer 300, and the multiple feed ground members are electrically connected with the multiple second metallization via holes 220c to electrically connect the second patch 220 and the feed ground layer 300.

Specifically, one first metallization via hole 210c is provided corresponding to one feed ground member, and one second metallization via hole 220c is provided corresponding to one feed ground member. The feed ground members are electrically connected with the first metallization via holes 210c to electrically connect the first patch 210 and the feed ground layer 300. The feed ground members are electrically connected with the second metallization via holes 220c to electrically connect the second patch 220 and the feed ground layer 300. The multiple feed ground members generate synchronous resonance to generate the RF signal of the second frequency band.

Reference can continue to be made to FIG. 10, the feed ground portion 400 includes a first part 401, a second part 402, and a third part 403 which are bendably connected, the second part 402 is connected between the first part 401 and the third part 403, the first part 401 is electrically connected with the patch array 200, and the third part 403 is electrically connected with the feed ground layer 300. The feed ground portion 400 is bent in a “H” shape.

An extension direction of the first part 401 keeps consistent with an extension direction of the third part 403. The first part 401 is connected between the patch array 200 and the second part 402, and the third part 403 is connected between the feed ground layer 300 and the second part 402. Specifically, the first part 401 is perpendicular to a plane on which the patch array 200 is located, and the third part 403 is perpendicular to a plane on which the feed ground layer 300 is located. A first preset included angle is defined between the first part 401 and the second part 402, and a second preset included angle is defined between the second part 402 and the third part 403. The first preset included angle ranges from 80°˜100°, and the second preset included angle ranges from 80°˜100°. The first preset included angle may be the same as or different from the second preset included angle. In an implementation, the first preset included angle is 90°, and the second preset included angle is 90°. In this case, the patch array 200, the first part 401, the second part 402, the third part 403, and the feed ground layer 300 keep perpendicular in sequence, such that the patch array 200, the first part 401, the second part 402, the third part 403, and the feed ground layer 300 can be relatively stably fixed to the dielectric substrate 100, which also helps to improve a yield rate when the antenna module 10 is prepared.

The second part 402 is a long-strip patch and has a first end 402a and a second end 402b opposite to the first end 402a. The first end 402a has a first electrical connection end 402c, and the second end 402b includes a second electrical connection end 402d. The first part 401 is electrically connected with the first electrical connection end 402c, and the third part 403 is electrically connected with the second electrical connection end 402d.

Specifically, the second part 402 has a long-strip structure and has the first end 402a and the second end 402b opposite to the first end 402a. The first end 402a has the first electrical connection end 402c, and the second end 402b has the second electrical connection end 402d. The first part 401 is electrically connected between the first electrical connection end 402c and the patch array 200, and the third part 403 is electrically connected between the second electrical connection end 402d and the feed ground layer 300. In this case, an intensity of the coupled current per unit area can be enhanced to facilitate adjustment of a frequency band of a RF signal received and emitted by the feed ground portion 400, which makes the feed ground portion 400 resonate in the preset frequency band.

Furthermore, the first part 401 and the third part 403 may also have a long-strip structure or a columnar structure. By bendably connecting the first part 401, the second part 402, and the third part 403, the transmission path of the coupled current coupled from the feeding portion 500 to the feed ground portion 400 can be extended, thereby improving the bandwidth of the RF signal received and emitted by the antenna module 10.

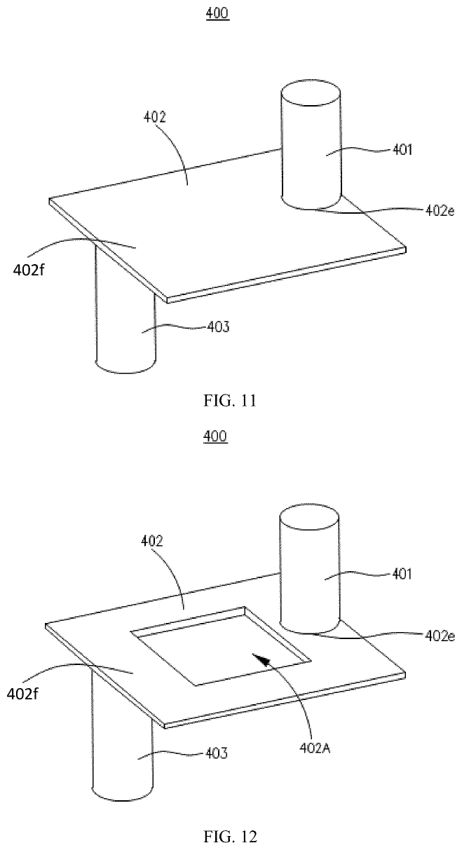

Reference can continue to be made to FIG. 11, and the second part 402 is a long-strip patch or a circular patch. The second part 402 has a third electrical connection end 402e and a fourth electrical connection end 402f spaced apart from the third electrical connection end 402e. The first part 401 is electrically connected with the third electrical connection end 402e, and the third part 403 is electrically connected with the fourth electrical connection end 402f.

Specifically, in an implementation, the second part 402 may be a rectangular patch or the circular patch, or may be an oblong patch or a square patch. The second part 402 has the third electrical connection end 402e and the fourth electrical connection end 402f spaced apart from the third electrical connection end 402e. The first part 401 is electrically connected with the third electrical connection end 402e and the patch array 200, and the third part 403 is electrically connected with the fourth electrical connection end 402f and the feed ground layer 300. In this case, an area of the second part 402 can be increased, when the current signal on the feeding portion 500 is coupled to the feed ground portion 400, transmission of the coupled current can be relatively uniform by increasing a pavement area of the coupled current, thereby making the performance of receiving and emitting the RF signal by the antenna module 10 relatively stable.

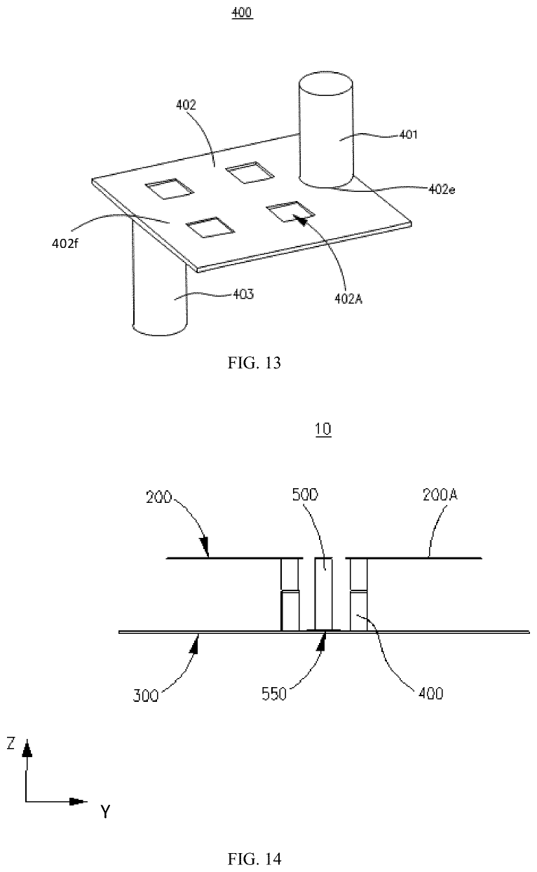

Reference can continue to be made to FIG. 12 and FIG. 13, furthermore, the second part 402 defines an escape hole 402A, the escape hole 402A avoids the third electrical connection end 402e and the fourth electrical connection end 402f, and the escape hole 402A and the at least one through hole 200a are arranged in a staggered manner.

The escape hole 402A is in any one or any combination of: a rectangle, a circle, an ellipse, a triangle, a pentagon, a hexagon, a cross, a quincunx, a C-shape, a U-shape, a S-shape, and a Jerusalem cross.

Specifically, in this implementation, the second part 402 defines one or more escape holes 402A. When the current signal on the feeding portion 500 is coupled to the feed ground portion 400, the coupled current on the second part 402 can be transmitted along multiple transmission paths, such that the transmission path of the coupled current can be extended, thereby improving the bandwidth of the RF signal received and emitted by the antenna module 10. The third electrical connection end 402e and the fourth electrical connection end 402f are disposed to avoid the escape hole 402A, which can keep an electrical connection relationship between the feed ground portion 400 and the patch array 200 and an electrical connection relationship between the feed ground portion 400 and the feed ground layer 300 stable. The escape hole 402A and the at least one through hole 200a are arranged in a staggered manner, such that a resonant signal generated by the second part 402 can be radiated though the escape hole 402A, thereby improving a radiation gain of the antenna module 10.

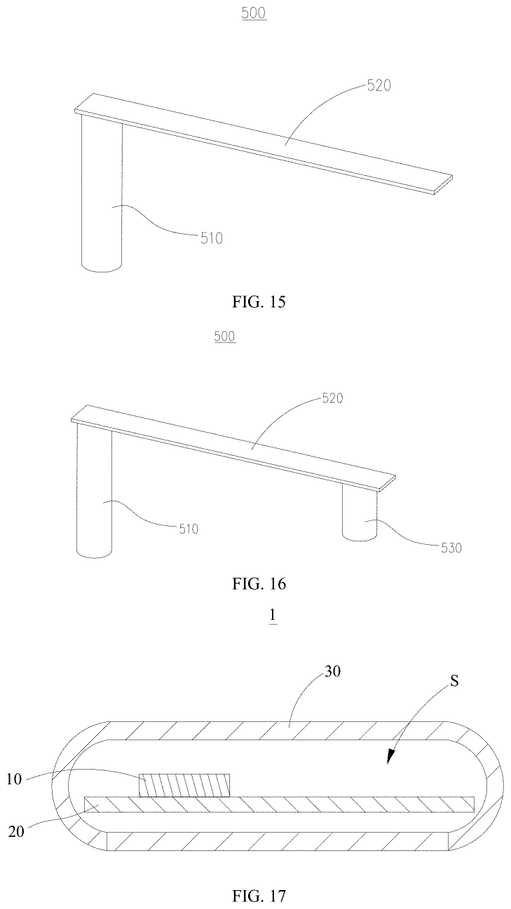

Reference can continue to be made to FIG. 14 and FIG. 15, and the antenna module 10 includes a feeding port 550. The feeding port 550 has a first section 510 and a second section 520 bendably connected with the first section 510, the first section 510 is electrically connected with the feeding port 550, the first section 510 is disposed close to the feed ground portion 400, the second section 520 is disposed close to the patch array 200, and the second section 520 is located between two adjacent patch units 200A.

Specifically, the antenna module 10 further includes a RF chip. The RF chip includes the feeding port 550. The feeding portion 500 is L-shaped and has the first section 510 and the second section 520 bendably connected with the first section 510. The first section 510 is electrically connected the feeding port 550, and the first section 510 is disposed close to the feed ground portion 400, which facilitates a current signal on the first section 510 being coupled to the feed ground portion 400. The second section 520 is disposed close to the patch array 200 and is located between two adjacent patch units 200A, which facilitates a current signal on the second section 520 being coupled to the patch array 200.

In a specific implementation, the second section 520 and the patch array 200 are disposed side by side, and the second section 520 and the patch array 200 keep flush with each other.

Specifically, the second section 520 is spaced apart from the patch array 200, when the second section 520 and the patch array 200 keep flush with each other, the current signal on the second section 520 can be relatively conveniently coupled to the patch array 200, such that the patch array 200 can resonate in the first frequency band, thereby generating the RF signal of the first frequency band.

Furthermore, the first section 510 is spaced apart from the feed ground portion 400, and the first section 510 is disposed close to the feed ground portion 400, such that the current signal on the first section 510 can be relatively conveniently coupled to the patch array 200 to make the feed ground portion 400 resonate in the second frequency band. In an implementation, the first section 510 keeps perpendicular to the second section 520, such that the first section 510 and the second section 520 are relatively stably carried on the dielectric substrate 100, which helps to improve the yield rate of preparation of the antenna module 10.

Reference can continue to be made to FIG. 14 and FIG. 16, and the antenna module 10 includes a feeding port 550. The feeding portion 500 has a first section 510, a second section 520, and a third section 530 which are bendably connected, the second section 520 is connected between the first section 510 and the third section 530, and the first section 510 is electrically connected with the feeding port 550. The first section 510 is disposed closed to the feed ground portion 400, and the second section 520 is disposed closed to the patch array 200. An extension direction of the third section 530 keeps consistent with an extension direction of the first section 510. The third section 530 is configured to perform spatial impedance matching on a RF signal of the first frequency band and the second frequency band received and emitted by the patch array 200.

Specifically, in this implementation, the feeding portion 500 has the first section 510, the second section 520, and the third section 530 which are bendably connected. The first section 510 is electrically connected with the feeding port 550. The extension direction of the first section 510 keeps consistent with the extension direction of the third section 530s. The second section 520 is connected between the first section 510 and the third section 530. The first section 510 and the third section 530 are disposed closed to the feed ground portion 400, and the second section 520 is disposed closed to the patch array 200. The third section 530 is configured to perform the spatial impedance matching on the RF signal of the preset frequency band received and emitted by the patch array 200, in other words, a length of the third section 530 can adjust a frequency of the RF signal received and emitted by the patch array 200.

Furthermore, a distance between the third section 530 and the feed ground layer 300 ranges from λ8˜λ/4, λ being a wavelength corresponding to an intermediate value of a center frequency of the first frequency band and a center frequency of the second frequency band. When the distance between the third section 530 and the feed ground layer 300 is within λ8˜λ/4, the length of the third section 530 ranges from λ/8˜λ/4, in this case, the frequency of the RF signal received and emitted by the patch array 200 can be adjusted, so as to make the antenna module 10 have higher radiation efficiency.

Reference can continue to be made to FIG. 17, and an electronic device 1 is also provided in implementations of the present disclosure. The electronic device 1 includes a main board 20 and the antenna module 10 which is provided in any of the above implementations. The antenna module 10 is electrically connected with the main board 20, and the antenna module 10 is configured to receive and emit the RF signal of the first frequency band and the second frequency band under control of the main board 20.

The electronic device 1 may be any device with a communication function, for example, a tablet computer, a mobile phone, an e-reader, a remote control, a personal computer (PC), a laptop, an in-vehicle device, a network TV, a wearable device, and other smart devices with the communication function.

The main board 20 may be a printed circuit board (PCB) of the electronic device 1. The main board 20 is electrically connected with the antenna module 10 and is provided with an excitation source. The excitation source is configured to generate an excitation signal, and the excitation signal is used to control the antenna module 10 to receive and emit the RF signal of the first frequency band and the second frequency band.

The electronic device 1 provided in implementations of the present disclosure includes the main board 20 and the antenna module 10 which are electrically connected. Each of the multiple patch units 200A defines at least one through hole 200a, which can extend a transmission path of the current, broaden an operating frequency band of the antenna module 10, and reduce the volume of the antenna module 10 to make the antenna module 10 miniaturized. In addition, the feeding portion 500 performs coupling feed on the antenna array and the feed ground portion 400, which can make the antenna module 10 operate in the same frequency band or different frequency bands, thereby helping to realize receiving and emitting of the RF signal of the single frequency band or the dual frequency band. When the antenna module 10 is applicable to the electronic device 1, the thickness of the electronic device 1 can be reduced.

The electronic device 1 further includes a battery cover 30. The battery cover 30 is spaced apart from the antenna module 10, and the battery cover 30 is at least partially located within a radiation direction range of receiving and emitting the RF signal by the antenna module 10. The antenna module 10 is configured to receive and emit the RF signal of the first frequency band and the second frequency band through the battery cover 30 under control of the main board 20. The battery cover 30 is made of any one or more of: plastic, glass, sapphire, and ceramic.

Specifically, in a structural arrangement of the electronic device 1, the battery cover 30 is at least partially located within the radiation direction range of receiving and emitting the RF signal by the antenna module 10, therefore, the battery cover 30 can also have an impact on radiation characteristics of the antenna module 10. Therefore, the RF signal received and emitted by the antenna module 10 can be transmitted through the battery cover 30, which can make the antenna module 10 have stable radiation performance in the structural arrangement of the electronic device 1. In other words, the battery cover 30 will not block transmission of the RF signal, and the battery cover 30 may be made of any one or any combination of: plastic, glass, sapphire, and ceramic.

Furthermore, the main board 20 is located at a side of the antenna module 10 away from the battery cover 30, and the main board 20 is configured to reflect the RF signal of the first frequency band and the second frequency band emitted by the antenna module 10 toward a side where the battery cover 30 is located.

The main board 20 is spaced apart from the battery cover 30, the battery cover 30 defines an accommodating space S, and the main board 20 is located in the accommodating space S. The antenna module 10 is electrically connected with the main board 20, the main board 20 is at least partially configured to reflect the RF signal of the first frequency band and the second frequency band emitted by the antenna module 10, such that a reflected RF signal of the first frequency band and the second frequency band is radiated to free space through the battery cover 30. The main board 20 is also configured to reflect a RF signal of the first frequency band and the second frequency band radiated from the free space through the battery cover 30 to the antenna module 10 toward a radiation surface of the antenna module 10.

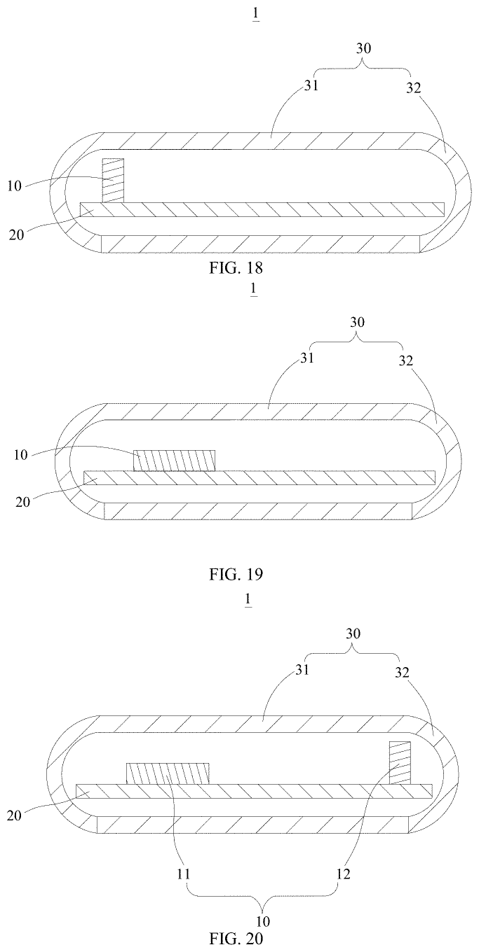

Reference can continue to be made to FIG. 18, the battery cover 30 includes a back plate 31 and a side plate 32 surrounding the back plate 31, and the side plate 32 is located within the radiation direction range of receiving and emitting the RF signal of the first frequency band and the second frequency band by the antenna module 10.

Specifically, when a radiation direction of the antenna module 10 faces the side plate 32 of the battery cover 30, the side plate 32 can be adopted to perform the spatial impedance matching on the RF signal received and emitted by the antenna module 10, in this case, the structural arrangement of the antenna module 10 in a whole device environment of the electronic device 1 is fully considered, as such, radiation effect of the antenna module 10 in the whole device environment can be ensured.

Reference can continue to be made to FIG. 19, the battery cover 30 includes a back plate 31 and a side plate 32 surrounding the back plate 31, and the back plate 31 is located within the radiation direction range of receiving and emitting the RF signal of the first frequency band and the second frequency band by the antenna module 10.

Specifically, when the antenna module 10 faces the back plate 31 of the battery cover 30, the back plate 31 can be adopted to perform the spatial impedance matching on the RF signal received and emitted by the antenna module 10, in this case, the structural arrangement of the antenna module 10 in the whole device environment of the electronic device 1 is fully considered, as such, the radiation effect of the antenna module 10 in the whole device environment can be ensured.

Reference can continue to be made to FIG. 20, the battery cover 30 includes a back plate 31 and a side plate 32 surrounding the back plate 31, the antenna module 10 includes a first module 11 and a second module 12, the first module 11 has a radiation surface facing the back plate 31, and the second module 12 has a radiation surface facing the side plate 32.

Specifically, in this implementation, the first module 11 and the second module 12 have different radiation directions. The first module 11 has the radiation surface facing the back plate 31, and the second module 12 has the radiation surface facing the side plate 32, such that directions of receiving and emitting RF signal by the antenna module 10 can be diversified. When one direction of receiving and emitting the RF signal by the antenna module 10 is blocked, another direction can be adopted to receive and emit the RF signal, such that the antenna module 10 can receive and emit the RF signal relatively stably.

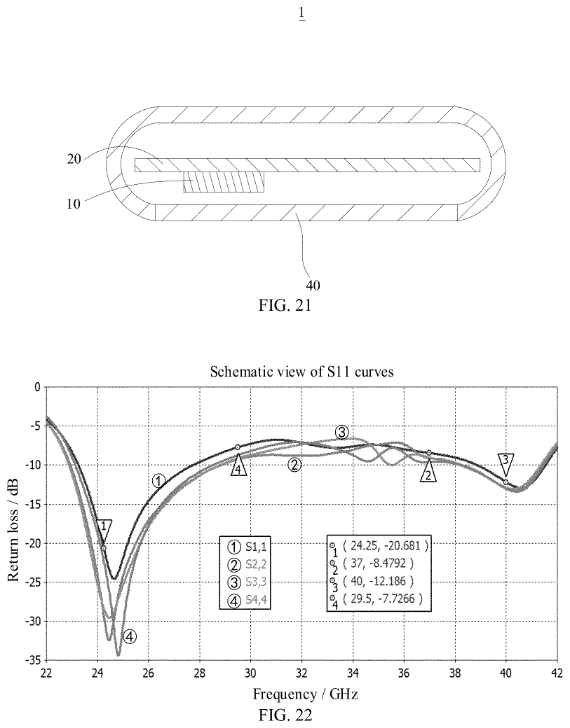

Reference can continue to be made to FIG. 21, and the electronic device 1 further includes a screen 40. The screen 40 is spaced apart from the antenna module 10, and the screen 40 is at least partially located within the radiation direction range of receiving and emitting the RF signal of the first frequency band and the second frequency band by the antenna module 10.

Specifically, when the antenna module 10 faces the screen 40, the screen 40 can be adopted to perform the spatial impedance matching on the RF signal received and emitted by the antenna module 10, in this case, the structural arrangement of the antenna module 10 in the whole device environment of the electronic device 1 is fully considered, as such, the radiation effect of the antenna module 10 in the whole device environment can be ensured.

Reference can continue to be made to FIG. 22, which is a schematic view illustrating a return loss curve of each port of a 1×4 antenna array. The abscissa represents the frequency in units of GHz, and the ordinate represents the return loss in units of decibel (dB). In the present disclosure, the 1×4 antenna array has the size of 20 mm×3.8 mm×0.8 mm, and the antenna array has the thickness of 0.8 mm. In FIG. 22, four ports of the 1×4 antenna array are marked as S1,1, S2,2, S3,3, and S4,4 respectively, and corresponding return loss curves are \textcircled{1}, \textcircled{2}, \textcircled{3}, and \textcircled{4} in sequence. It can be seen that since the 1×4 antenna array is disposed in mirror symmetry, a return loss curve corresponding to port S1,1 of the antenna array basically coincides with a return loss curve \textcircled{1} corresponding to port S4,4 of the antenna array, and a return loss curve \textcircled{2} corresponding to port S2,2 of the antenna array basically coincides with a return loss curve \textcircled{3} corresponding to port S3,3 of the antenna array. At mark point 1, a frequency is 24.25 GHz, and a corresponding return loss is −20.681 dB. At mark point 2, the frequency is 37 GHz, and the corresponding return loss is −8.4792 dB. At mark point 3, the frequency is 40 GHz, and the corresponding return loss is −12.186 dB. At mark point 4, the frequency is 29.5 GHz, and the corresponding return loss is −7.7266 dB. In other words, the 1×4 antenna array can cover a full frequency band of n257, n258, n261, and n260 mmWave. When S11≤−10 dB, a frequency band ranges from 23 GHz˜41.6 GHz, and the 1×4 antenna array has an impedance bandwidth of 18.6 GHz.

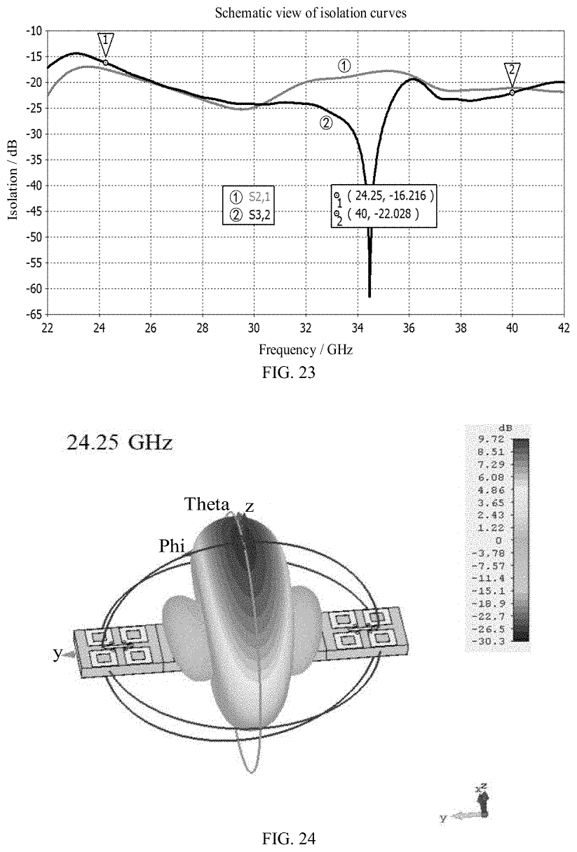

Reference can continue to be made to FIG. 23, which is a schematic view illustrating isolation curves between patch-unit ports of a 1×4 antenna array. The abscissa represents the frequency in units of GHz, and the ordinate represents the isolation in units of dB. In FIG. 23, patch-unit ports in the same antenna module are marked as S2,1 and S3,2. At mark point 1, the frequency is 24.25 GHz, and the corresponding isolation is −16.216 dB. At mark point 2, the frequency is 40 GHz, and the corresponding isolation is −22.028 dB. In other words, the 1×4 antenna array can cover the full frequency band of n257, n258, n261, and n260 mmWave. In addition, isolation between the patch-unit ports is relatively large, which can avoid mutual interference between adjacent patch units.

Reference can continue to be made to FIG. 24, which is a radiation gain pattern illustrating an antenna module in a frequency band of 24.25 GHz in a main direction. Z axis represents a radiation direction of an antenna module, and XY axis represents a radiation angle of the antenna module relative to a main lobe. It can be seen that at a resonant frequency point of 24.25 GHz, a gain is greatest, a directivity is greatly improved, and a peak gain reaches 9.72 dB.

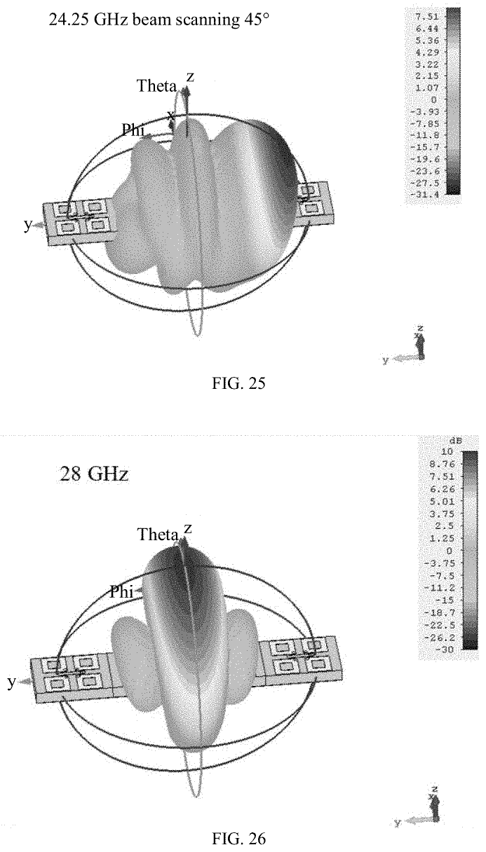

Reference can continue to be made to FIG. 25, which is a radiation gain pattern illustrating an antenna module in a frequency band of 24.25 GHz in a 45-degree direction. Z axis represents the radiation direction of the antenna module, and XY axis represents the radiation angle of the antenna module relative to the main lobe. It can be seen that at the resonant frequency point of 24.25 GHz, the gain is greatest, the directivity is greatly improved, and the peak gain reaches 7.51 dB.

Reference can continue to be made to FIG. 26, which is a radiation gain pattern illustrating an antenna module in a frequency band of 28 GHz. Z axis represents the radiation direction of the antenna module, and XY axis represents the radiation angle of the antenna module relative to the main lobe. It can be seen that at the resonant frequency point of 28 GHz, the gain is greatest, the directivity is greatly improved, and the peak gain reaches 10 dB.

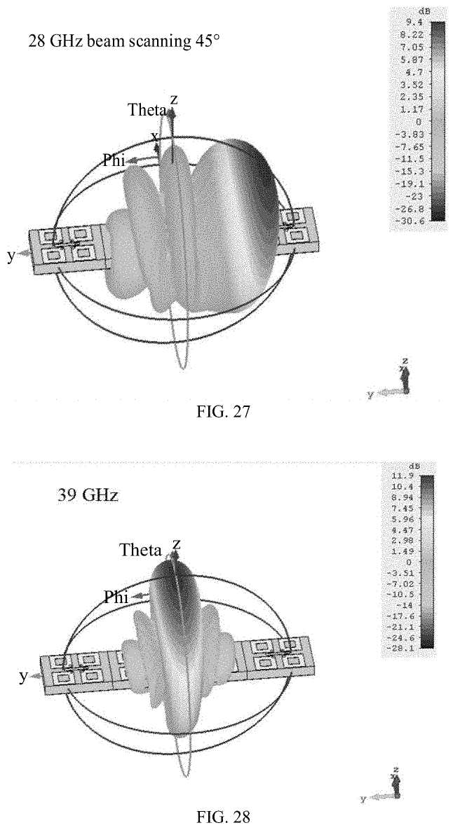

Reference can continue to be made to FIG. 27, which is a radiation gain pattern illustrating an antenna module in in a frequency band of 28 GHz in a 45-degree direction. Z axis represents the radiation direction of the antenna module, and XY axis represents the radiation angle of the antenna module relative to the main lobe. It can be seen that at the resonant frequency point of 28 GHz, the gain is greatest, the directivity is greatly improved, and the peak gain reaches 9.4 dB.

Reference can continue to be made to FIG. 28, which is a radiation gain pattern illustrating an antenna module in in a frequency band of 39 GHz. Z axis represents the radiation direction of the antenna module, and XY axis represents the radiation angle of the antenna module relative to the main lobe. It can be seen that at the resonant frequency point of 39 GHz, the gain is greatest, the directivity is greatly improved, and the peak gain reaches 11.9 dB.

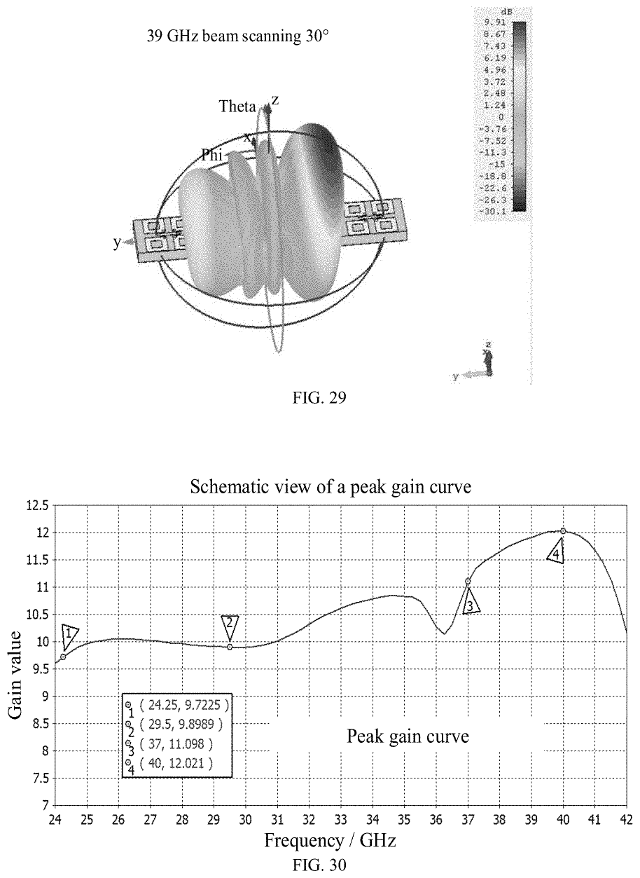

Reference can continue to be made to FIG. 29, which is a radiation gain pattern illustrating an antenna module in in a frequency band of 39 GHz in a 30-degree direction. Z axis represents the radiation direction of the antenna module, and XY axis represents the radiation angle of the antenna module relative to the main lobe. It can be seen that at the resonant frequency point of 39 GHz, the gain is greatest, the directivity is greatly improved, and the peak gain reaches 9.91 dB.

Reference can continue to be made to FIG. 30, which is a schematic view illustrating a variation curve of a peak gain of an antenna module with a frequency. The abscissa represents the frequency in units of GHz, and the ordinate represents the peak gain. At mark point 1, a frequency is 24.25 GHz, and a corresponding peak gain is 9.7225. At mark point 2, the frequency is 29.5 GHz, and the corresponding peak gain is 9.8989. At mark point 3, the frequency is 37 GHz, and the corresponding peak gain is 11.098. At mark point 4, the frequency is 40 GHz, and the corresponding peak gain is 12.021. It can be seen that the 1×4 antenna array can cover the full frequency band of n257, n258, n261, and n260 mmWave, in addition, with the frequency increasing from 24.25 GHz to 40 GHz, the peak gain of the antenna module basically increases gradually, and with the frequency increasing from 40 GHz to 42 GHz, the peak gain of the antenna module gradually decreases.

The above implementations in the present disclosure are described in detail. Principles and implementation manners of the present disclosure are elaborated with specific implementations herein. The above illustration of implementations is only used to help to understand methods and core ideas of the present disclosure. At the same time, for those of ordinary skill in the art, according to ideas of the present disclosure, there will be changes in specific implementation manners and application scope. In summary, contents of this specification should not be understood as limitations on the present disclosure.

What is claimed is:

1. An antenna module, comprising:
a dielectric substrate;
a patch array carried on the dielectric substrate and comprising at least two patch units, wherein each of the at least two patch units defines at least one through hole;
a feed ground layer carrying the dielectric substrate and spaced apart from the patch array;
a feed ground portion electrically connected between the patch array and the feed ground layer; and
a feeding portion configured to feed a current signal, wherein the current signal is coupled to the patch array to excite the patch array to resonate in a first frequency band, and the current signal is coupled to the feed ground portion to excite the feed ground portion to resonate in a second frequency band.

2. The antenna module of claim 1, wherein the patch array comprises a first patch and a second patch spaced apart from the first patch, the first patch defines a first through hole, the second patch defines a second through hole, and the first patch and the second patch are disposed in mirror symmetry.

3. The antenna module of claim 2, wherein the first patch comprises a first feed ground point, and the second patch comprises a second feed ground point;
the feed ground portion comprises a first feed ground member and a second feed ground member spaced apart from the first feed ground member, and a length of at least one of the first feed ground member and the second feed ground member is greater than a distance between a surface of the patch array facing the feed ground layer and a surface of the feed ground layer facing the patch array; and
the first feed ground member is electrically connected between the first feed ground point and the feed ground layer, and the second feed ground member is electrically connected between the second feed ground point and the feed ground layer.

4. The antenna module of claim 2, wherein the first patch defines a first accommodating hole at an edge part of the first patch away from the feeding portion, the second patch defines a second accommodating hole at an edge part of the second patch away from the feeding portion, each of the first accommodating hole and the second accommodating hole is a through hole, and an opening direction of the first accommodating hole is opposite to an opening direction of the second accommodating hole.

5. The antenna module of claim 2, wherein the first patch defines a first curved gap at a middle part of the first patch away from the feeding portion, the second patch defines a second curved gap at a middle part of the second patch away from the feeding portion, each of the first curved gap and the second curved gap is a through hole, and an opening direction of the first curved gap is opposite to an opening direction of the second curved gap.

6. The antenna module of claim 2, wherein the first patch defines a plurality of first metallization via holes arranged in an array at an edge part of the first patch close to the feeding portion, and the second patch defines a plurality of second metallization via holes arranged in an array at an edge part of the second patch close to the feeding portion.

7. The antenna module of claim 1, wherein a length of the feed ground portion is greater than a distance between a surface of the patch array facing the feed ground layer and a surface of the feed ground layer facing the patch array.

8. The antenna module of claim 7, wherein the feed ground portion comprises a first part, a second part, and a third part which are bendably connected, the second part is connected between the first part and the third part, the first part is electrically connected with the patch array, and the third part is electrically connected with the feed ground layer.

9. The antenna module of claim 8, wherein the first part is perpendicular to a plane on which the patch array is located, the third part is perpendicular to a plane on which the feed ground layer is located, a first preset included angle is defined between the first part and the second part, a second preset included angle is defined between the second part and the third part, the first preset included angle ranges from 80°˜100°, and the second preset included angle ranges from 80°˜100°.

10. The antenna module of claim 8, wherein the second part is a long-strip patch, a square patch, or a circular patch, the second part has a first end and a second end opposite to the first end, the first end has a first electrical connection end, the second end has a second electrical connection end, the first part is electrically connected with the first electrical connection end, and the third part is electrically connected with the second electrical connection end.

11. The antenna module of claim 10, wherein the second part defines an escape hole, the escape hole avoids the first electrical connection end and the second electrical connection end, and the escape hole and the at least one through hole are arranged in a staggered manner.

12. The antenna module of claim 1, wherein the patch array constitutes an electric dipole antenna, the feed ground portion constitutes a magnetic dipole antenna, and a radiation direction of the patch array keeps orthogonal to a radiation direction of the feed ground portion.

13. The antenna module of claim 12, wherein a projection of the patch array on the dielectric substrate is located within a range of a projection of the feed ground layer on the dielectric substrate.

14. The antenna module of claim 12, wherein the first frequency band is different from the second frequency band, a minimum value of the first frequency band is greater than a maximum value of the second frequency band, the first frequency band and the second frequency band together constitute a preset frequency band, and the preset frequency band at least comprises a full frequency band of 3rd generation partnership project (3GPP) millimeter wave (mmWave).

15. The antenna module of claim 1, wherein a size of the feed ground layer is λ×λ, and a distance between the patch array and the feed ground layer is λ/4, λ being a wavelength corresponding to an intermediate value of a center frequency of the first frequency band and a center frequency of the second frequency band.

16. The antenna module of claim 1, further comprising:
a feeding port, wherein the feeding portion has a first section and a second section bendably connected with the first section, the first section is electrically connected with the feeding port, the first section is disposed close to the feed ground portion, the second section is disposed close to the patch array, and the second section is located between two adjacent patch units.

17. The antenna module of claim 1, further comprising:
a feeding port, wherein the feeding portion has a first section, a second section, and a third section which are bendably connected, the second section is connected between the first section and the third section, the first section is electrically connected with the feeding port, the first section is disposed closed to the feed ground portion, the second section is disposed closed to the patch array, an extension direction of the third section keeps consistent with an extension direction of the first section, and the third section is configured to perform spatial impedance matching on a radio frequency (RF) signal of the first frequency band and the second frequency band received and emitted by the patch array.

18. An electronic device, comprising:
a main board; and
an antenna module, wherein the antenna module is electrically connected with the main board, and the antenna module is configured to receive and emit a radio frequency (RF) signal of a first frequency band and a second frequency band under control of the main board;
wherein the antenna module comprises:
a dielectric substrate;
a patch array carried on the dielectric substrate and comprising at least two patch units, wherein each of the at least two patch units defines at least one through hole;
a feed ground layer carrying the dielectric substrate and spaced apart from the patch array;
a feed ground portion electrically connected between the patch array and the feed ground layer; and
a feeding portion configured to feed a current signal, wherein the current signal is coupled to the patch array to excite the patch array to resonate in the first frequency band, and the current signal is coupled to the feed ground portion to excite the feed ground portion to resonate in the second frequency band.

19. The electronic device of claim 18, further comprising:
a battery cover, wherein the battery cover is spaced apart from the antenna module, the battery cover is at least partially located within a radiation direction range of receiving and emitting the RF signal by the antenna module, and the antenna module is configured to receive and emit the RF signal of the first frequency band and the second frequency band through the battery cover under control of the main board.

20. The electronic device of claim 18, further comprising:
a screen, wherein the screen is spaced apart from the antenna module, and the screen is at least partially located within a radiation direction range of receiving and emitting the RF signal of the first frequency band and the second frequency band by the antenna module.
